(19) United States
(12) Patent Application Publication
(10) Pub. No.: US 2005/0055483 A1
(43) Pub. Date: Mar. 10, 2005

(54) System and method for file comperssion

(76) Inventors: William Lee Devlin, Greeley, CO (US); Charles Robert Weirauch, Loveland, CO (US)

Correspondence Address: HEWLETT-PACKARD COMPANY;Intellectual Property Administration, P.O. Box 272400, Fort Collins, CO, 80527-2400, US

(21) Appl. No.: 10/646,012

(22) Filed: Aug. 22, 2003

(51) Int. Cl. H04N 7/12

(52) U.S. Cl. 710/68; 375/240; 375/240.01; 348/384.1

(57) ABSTRACT

A file compression method comprises receiving a file from a processor by a video capture device, compressing the file into a compressed file by the video capture device, and outputting the compressed file by the video capture device to the processor.

### BACKGROUND

As the use of Personal Computers (PCs) for multimedia file manipulation (such as video editing, video rendering, video compression, and multitasking of applications) becomes more common, problems arise because of Central Processing Unit (CPU) limited bandwidth. Overall system performance may be degraded while carrying out such tasks. Oftentimes, a digital video file is converted into a format, such as the Motion Picture Expert Group-2 (MPEG-2) format that is compatible with Digital Versatile Disk (DVD) standards. After adding the necessary DVD navigation information, the file may be written to a DVD so the file may be viewed using consumer electronics devices, such as a DVD player. The operation to convert from, for example, the Digital Video (DV) format into a DVD format such as MPEG-2, requires as much time, on current PCs, as three hours per hour of video. During the conversion time, the PC is usually unable to reasonably multitask or perform any other tasks.

Video compression is generally performed by individual compression of each frame of video or by interframe compression, wherein the compression and decompression is dependent on one or more adjacent frames of video. Video editing on a PC is best done in an uncompressed digital format or in a format where each frame is independently compressed, for example, the video format that is output from DV cameras. Editing compressed streams may be slow because interframe compression must be “undone” in real time to make each video frame available. Additionally, interframe compression, such as with MPEG formats, tends to be a more lossy compression than individual frame compression such as the DV format. Therefore, many users prefer to edit raw, uncompressed video directly, such as from a DV source or the like. However, after the editing is complete, in order to write the video to a Video Compact Disk (VCD) or DVD, or to use the video as part of an Internet stream, the video needs to be compressed. Transcoding may be used to convert a DV or similarly formatted file into an MPEG-2 format or the like so that the file will be suitable for writing to a DVD. The majority of software applications for transcoding from DV to MPEG convert DV to uncompressed video before beginning interframe compression. The amount of computer bandwidth required to carry out this conversion may be overly burdensome for a PC. Software-based MPEG compression may take many hours of CPU time per hour of video. MPEG encoding software is computationally intensive and renders a PC's CPU unavailable for other tasks while compressing video data.

A video capture device is optimized for video or multimedia file compression. These video capture devices may be used to convert analog video, such as from VHS or 8 mm video tapes, to a DVD-compatible format or the like. Many video capture devices include hardware logic to facilitate the compression of video, while others pass uncompressed video to the host PC for compression using software.

MPEG compression chips are frequently used in video capture devices. As used herein, a video capture device is a device that is intended to convert an analog signal to a digital signal and to compress the digital signal by a factor of about 100 into an MPEG stream, or the like. Typically, a video capture device employs an analog to digital (A/D) converter to provide an uncompressed digital video stream into the MPEG compressor. The digital video stream is typically provided to the compressor chip at 200 megabits per second and the file is compressed, such as by a factor of 50 or 100, using a standard compression format such as MPEG-2. The resulting MPEG stream may then be saved as a file on a PC or written to a DVD.

The algorithms enabling compression in video capture devices are very well tested, unlike the algorithms used in computers as part of software compression applications that may have been written by hundreds of different programmers. There is a likelihood that such software compression applications will lock up or be incompatible with other programs on the PC. Other programs running on the PC may cause a video compression program to freeze, thereby losing any video compression up to that point. On the other hand, a video capture device is designed specifically for one task. Video compression devices have an extra degree of stability and are much less likely to have software inconstancies, to crash or to lockup.

There is no existing system or method to take advantage of MPEG compressor chip functionality other than for analog video input. Video compression chips typically perform their task external to a PC. The bandwidth of interfaces such as Universal Serial Bus Version 2.0 (USB 2.0) and “firewire” IEEE 1394 have only recently become fast enough to support uncompressed video streams. However, there is no existing manner of taking advantage of the compression engines that reside external to the PC on external video compression devices because the existing path is “one-way,” from the video capture device to the PC.

### SUMMARY

An embodiment of a file compression method comprises receiving a file from a processor by a video capture device, compressing the file into a compressed file by the video capture device, and outputting the compressed file by the video capture device to the processor.

An embodiment of a file compression device comprises a compression encoder comprising means for receiving a digital data stream, and means for converting the digital data stream into a compressed data stream; and a controller comprising means for receiving a high speed input stream of a digital file from a processor device, means for inputting the input stream into the compression encoder for compression, and means for receiving compressed files from the compression encoder for output, as an output stream to the processor.

An embodiment of a system comprises a video capture device comprising an analog-to-digital converter, a multimedia compression encoder comprising means for receiving a digital data stream and means for converting the digital data stream into a compressed multimedia data stream, and an internal bus for carrying the digital data stream from the analog-to-digital converter to the encoder; and a controller comprising means for receiving a high speed input stream of a digital multimedia file from a processor, means for inputting the input stream into the internal bus for compression by the encoder, means for receiving compressed multimedia files from the multimedia compression encoder, and means for outputting the compressed multimedia file as an output stream to the processor.

### BRIEF DESCRIPTION OF THE DRAWINGS

FIG. 1 is an environmental view of a system adapted for use of an embodiment of the present invention;

FIG. 2 is a diagrammatic view of data flow in an embodiment of the present invention;

FIG. 3 is a flow chart of an embodiment of the present method; and

FIG. 4 is a diagrammatic view of a video capture device adapted according to embodiments of the present invention.

### DETAILED DESCRIPTION

The present invention provides for use of an external multimedia capture and encoder device to compress a digital multimedia stream into a compressed multimedia file. Systems and methods are described herein in relation to a video multimedia file. However, as one of ordinary skill in the art will appreciate, the present systems and methods are equally applicable to other types of multimedia files, such as audio or graphics files. The present systems and methods take advantage of MPEG processing chips, known as MPEG compressors. However, the present systems and method may also incorporate other types of multimedia compression technologies as well. Uncompressed digital video, such as video used or produced for display on a PC or the like, is fed as a digital stream into an MPEG compressor, such as at a rate of 200 megabits per second where the file is compressed, such as by a factor of 50 or 100 using a standard compression format such as MPEG-2. The present invention enables off-loading of the compression task from the PC, thereby enabling the task to be carried out at approximately a 1-to-1 speed or faster. Thus, an hour of video may still take an hour to compress, similar to speeds possible for compressing video using current PCs. Yet, the PC is useable for other tasks. Still, if the compression technology within the capture device and the interfacing technology is capable of handling compression and transmission rates faster than 1-to-1, even greater performance may be achieved.

Normally, video capture devices receive video from an analog device and convert the video into a compressed digital format, such as an MPEG. The present inventive systems and methods enable passing of uncompressed video from a PC or the like to a video capture device or the like for compression and passing of compressed data back to the PC. Embodiments in accordance with the present invention allow the PC to take advantage of the capture device's video compression engine, freeing up the PC's CPU for other tasks.

A video compression engine external to a PC may be accessed via a two-way communication path established in accordance with the present invention, in contrast to existing devices that have only one-way movement of the compressed video (i.e., from the external capture device to the PC). The present invention enables a simultaneous two-way transfer of the uncompressed and compressed data over a high speed bus, and uses the compression engine's hardware to avoid burdening the PC's CPU. A two-way channel to the video capture device allows the CPU to remain available for other tasks while the video stream is piped into and subsequently out of the compression engine. Handling the input/output (I/O) of the uncompressed and compressed video imposes a very low burden on the CPU. In addition, the time to compress the video may be reduced because the specialized hardware of the compression engine is optimized for compressing video.

An additional path constructed via an external bus between a PC and an external video capture device provides the advantage of enabling the PC to use the compression engine in the video capture device so that the video may be compressed without overly burdening the PC's CPU, allowing the PC to be used for other tasks.

Video capture devices are typically intended to capture analog video and to output digital video. A transition from analog to digital typically takes place, such as using A/D conversion, before compression may be carried out. The present invention takes advantage of the separation of the A/D process from the compression process within a video capture device. An uncompressed digital stream from a source other than the video capture device A/D converter, such as from a high speed external bus, may be input to the video compressor. When digital video residing on a PC or the like is edited and/or otherwise ready for authoring, a user may employ a high speed USB, firewire or other high speed connection to send uncompressed video to the video capture device that compresses the video stream into an MPEG stream. The compressed MPEG stream is delivered back to the PC over an external bus, while uncompressed video continues to stream to the MPEG compressor.

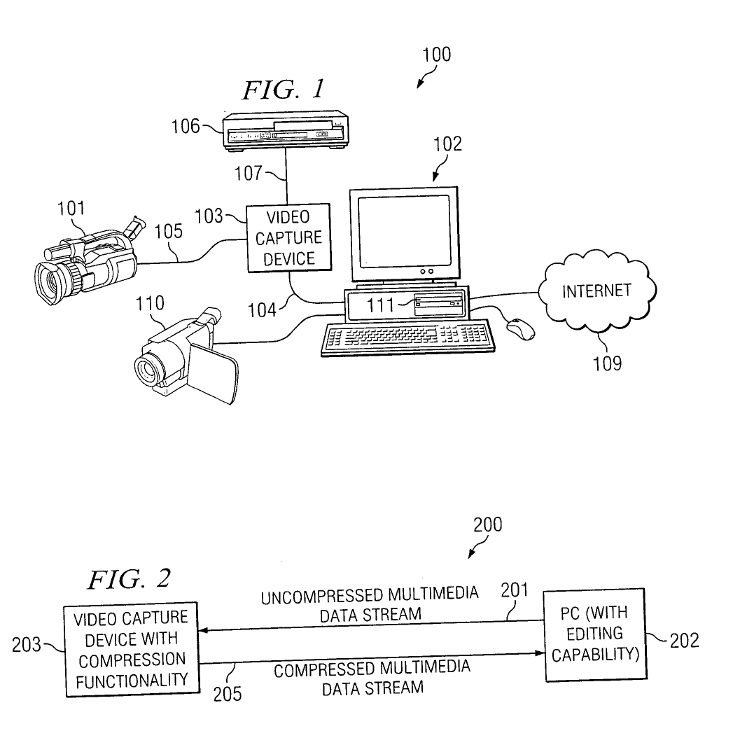

FIG. 1 is an environmental view of system 100 adapted for use in an embodiment of the present invention. Analog camcorder 101 is shown connected to PC 102 via analog cable 105, video capture device 103 and USB cable 104. Other analog video sources, such as VCR 106, may also or alternatively be connected to an analog input on video capture device 103, via analog cable 107. Video capture device 103 may convert analog input from analog sources 101 and 106 to a digital format and may provide compressed video to PC 102, via USB cable 105, for editing and/or storage.

A digital media source, such as Internet 109 (or similar network) or digital camcorder 110, may also be connected to PC 102. These sources may provide compressed and/or uncompressed digital video files that may be edited on PC 102 in an uncompressed format. These files may be provided to video capture device 103 by PC 102 in an uncompressed format for compression in accordance with the present invention. PC 102 may also host DVD writer 111, or the like, for publishing multimedia files compressed in accordance with the present invention. Internet 109 or digital camcorder 110 may also act as a medium for publishing video files compressed in accordance with the present invention. PC 102 may also host video-editing software, thus allowing PC 102 to function as a video editing station. As discussed in greater detail below, USB cable 104 may provide two-way data flow for PC 102, in accordance with the present invention, to stream an uncompressed multimedia file to video capture device 103 for compression and for video capture device 103 to stream the resultant compressed video file to PC 102 for authoring and/or storage. Alternatively, multiple external busses may be employed to transport uncompressed and compressed data between PC 102 and the video capture device 103. As a further alternative, DVD writer 111, or the like, may be combined with the external capture device in a single external enclosure.

FIG. 2 is a diagrammatic view of data flow 200 in accordance with embodiments of the present invention. Data flow 200 is a two-way data flow employed by the present systems and methods to assist the PC in making a file available and ready for DVD or similar authoring. PC 202 sends uncompressed multimedia data stream 201 to video capture device 203 that includes a compression integrated circuit (IC) or the like. Data stream 201, from PC 202 to video capture device 203, may be in a relatively uncompressed format, but the source of the data stream could be any number of compressed video formats, such as WINDOWS MEDIA™, REAL MEDIA™, MPEG and DiVX and a number of other video formats that are available from a variety of sources, such as by downloading from the Internet. These video sources may be somewhat compressed, but the video may have been uncompressed to be viewed, edited, and/or transcoded into a more useable format via the present invention. As provided above, a file or stream may be uncompressed before transcoding so that all video frames and all audio is present and in the proper sequence. As frames of uncompressed data stream 201 are being sent to video capture device 203, PC 202 is also gathering compressed frames of returned compressed multimedia data stream 205. These compressed frames are usually in a format such as MPEG-2, that is compatible with writing directly to a DVD without any further compression by PC 202.

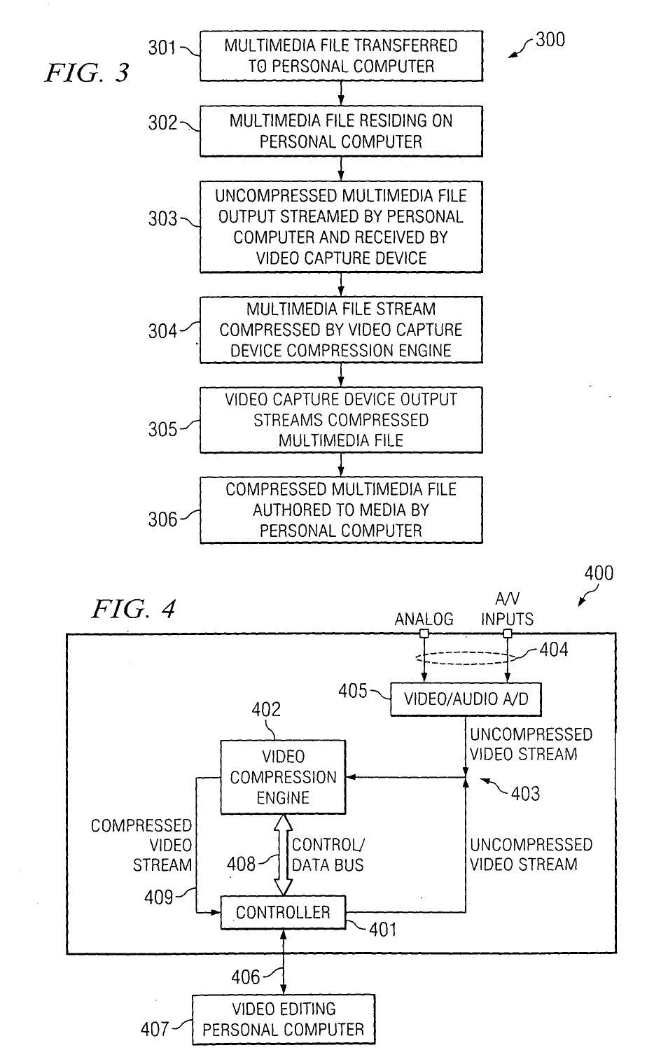

FIG. 3 is a flow chart of an embodiment 300 of the present method. At block 301 a multimedia file is transferred to a PC. For example, a DV camera may transfer a video file to a PC through a firewire connection, USB connection, or other high speed connection. At 302 the multimedia file is residing on the PC. This digital file may be either uncompressed, or compressed in an undesired format such as DV, REAL MEDIA™ or WINDOWS MEDIA™ and may be stored on the PC for editing, viewing or other use. At 303 an uncompressed multimedia file is output streamed by the PC and received by the video capture device. The file output to the video capture device may be an edited or otherwise altered version of the file residing on the PC. Also, the video capture device has preferably been structured in accordance with the present invention, as discussed in greater detail below. At 304 the multimedia file stream is compressed by the video capture device compression engine. The uncompressed file may be compressed into an MPEG-2 format or the like, by the video capture device's compression engine. At 305 the video capture device output streams the compressed multimedia file. The file may be output as a compressed data stream to the PC. At 306 the compressed multimedia file is shown as being authored to media by the PC. Thus, the compressed multimedia file may be authored or otherwise output to a DVD disk, the internet or the like at by the PC.

FIG. 4 is a diagrammatic view of video capture device 400 adapted according to embodiments of the present invention. Controller 401 includes a serial-to-parallel converter. The output of the serial-to-parallel converter of controller 401 is an uncompressed digital stream that is input to MPEG compressor 402 via internal bus 403. Bus 403 also carries uncompressed video signals and may be, for example, a “CCIR-656” bus and associated audio bus. Analog input 404 to device 400 is fed to A/D chip 405 that converts the analog video signal into standard digital video signals, such as “CCIR-656”, and accompanying analog sound signal into a digital sound signal. These signals are provided to MPEG chip 402 via bus 403 and an associated audio bus.

In order to interface with MPEG compressor 402, the present invention employs bridge serial-to-parallel converter logic (not shown) in controller 401. This bridge logic converts USB 2.0 input, or the like, into a General Purpose Input/Output (GPI/O) signal, or the like. Controller 401 may have a CPU that reads code and handles serialization and deserialization of data as the data is transferred to or from bus 406. Programmable logic contained in controller 401 may enable insertion of a raw uncompressed digital stream received via bus 406 from PC 407 or the like into MPEG chip 402 via bus 403. Controller 401 may synchronize video and audio input onto separate digital buses so that video compression engine 402 will receive the data and properly encode it in an MPEG format or the like and not lose synchronization between the audio and video. Parallel control/data bus 408 may be used by controller 401 to direct action of MPEG video compression engine 402 in accordance with the present invention. Controller 401 packetizes a serial MPEG stream 409 output by video compression engine 402 and directs the packetized stream onto bus 406 for transmission back to PC 407 for storage and/or authoring.

1. A file compression method comprising:
receiving a file from a processor by a video capture device;
compressing said file into a compressed file by said video capture device; and
outputting the compressed file by said video capture device to said processor.

2. The method of claim 1 wherein said file is a multimedia file.

3. The method of claim 1 wherein said file is a video file.

4. The method of claim 1 wherein said file is in a digital video format.

5. The method of claim 1 wherein said file is compressed.

6. The method of claim 5 wherein said compressed file is in a digital video format.

7. The method of claim 1 wherein said receiving and said outputting are carried out concurrently.

8. The method of claim 1 wherein said receiving and said outputting are carried out concurrently via a serial connection.

9. The method of claim 1 wherein said compressed file is in a Moving Pictures Experts Group format.

10. The method of claim 1 wherein said compressed file is in a Digital Versatile Disk compatible format.

11. The method of claim 1 further comprising:
publishing said compressed file using said processor device.

12. The method of claim 11 wherein said publishing comprises copying said compressed file to a Digital Versatile Disk.

13. A file compression device comprising:
a compression encoder comprising:
means for receiving a digital data stream; and
means for converting said digital data stream into a compressed data stream; and
a controller comprising:
means for receiving a high speed input stream of a digital file from a processor device;
means for inputting said input stream into said compression encoder for compression; and
means for receiving compressed files from said compression encoder for output, as an output stream to said processor.

14. The device of claim 13 wherein said controller further comprises:
means for deserializing said input stream; and
means for serializing said output stream.

15. The device of claim 13 further comprising a serial interface concurrently carrying said high speed input stream and said output stream between said controller and said processor.

16. The device of claim 13 wherein said high speed input stream is an uncompressed digital multimedia data stream.

17. The device of claim 13 wherein said means for converting comprises means for converting said digital data stream into a digital video format compatible for use on a Digital Versatile Disk.

18. The device of claim 17 wherein said format compatible for use on a Digital Versatile Disk is a Moving Pictures Experts Group format.

19. A system comprising:
a video capture device comprising:
an analog-to-digital converter;
a multimedia compression encoder comprising:
means for receiving a digital data stream; and
means for converting said digital data stream into a compressed multimedia data stream; and
an internal bus for carrying said digital data stream from said analog-to-digital converter to said encoder; and
a controller comprising:
means for receiving a high speed input stream of a digital multimedia file from a processor;
means for inputting said input stream into said internal bus for compression by said encoder;
means for receiving compressed multimedia files from said multimedia compression encoder; and
means for outputting said compressed multimedia file as an output stream to said processor.

20. The system of claim 19 wherein said means for outputting and said means for receiving concurrently carry said high speed input stream and said output stream between said controller and said processor.

21. The system of claim 19 wherein said means for receiving comprises:
means for deserializing said input stream; and
means for serializing said output stream.

22. The system of claim 19 wherein said output stream is in a Moving Pictures Experts Group format compatible for use on a Digital Versatile Disk.
